(19) United States
(12) Patent Application Publication
(10) Pub. No.: US 2013/0072385 A1
(43) Pub. Date: Mar. 21, 2013

(54) METHODS FOR DELAYING BUD BREAK BY APPLYING ABA ANALOGS

(71) Applicants: Derek D. Woolard, Zion, IL (US); Peter D. PETRACEK, Grayslake, IL (US)

(72) Inventors: Derek D. Woolard, Zion, IL (US); Peter D. PETRACEK, Grayslake, IL (US)

(21) Appl. No.: 13/617,702

(22) Filed: Sep. 14, 2012

Related U.S. Application Data
(60) Provisional application No. 61/534,967, filed on Sep. 15, 2011.

(51) Int. Cl. A01N 37/42; A01P 21/00

(52) U.S. Cl. 504/314; 504/320; 504/313

(57) ABSTRACT

The present invention is directed to methods for delaying bud break of perennial plants by applying abscisic acid (“ABA”) analogs to the plants before cold temperature induced dormancy in order to delay the timing of bud break in response to future temperature increases.

This application claims the benefit of U.S. Provisional Application Ser. No. 61/534,967 filed Sep. 15, 2011, incorporated herein by reference.

### FIELD OF THE INVENTION

The present invention relates to methods for delaying bud break in plants by applying abscisic acid analogs to the plants before the plants become dormant in response to exposure to colder temperatures.

### BACKGROUND OF THE INVENTION

Controlling the timing of bud break of perennial plants by delaying the emergence of their green shoots from their buds could significantly decrease cold temperature damage to the plants. In some spring seasons, there is an unexpected period of warm weather early in the season. If this period of warm weather causes bud break, the buds are vulnerable to exposure to freezing temperatures that could damage or kill the buds. The death of the buds could eliminate the plants' potential to produce harvestable products. Obviously, this scenario could devastate the growers' profits for the year and would be undesirable. Unfortunately, there is no way to predict if there will be a period of time in early spring when there is unseasonably warm weather. Therefore, there is a need to delay the time of bud break until after the risk of frost and cold stress is reduced in the area in which the plants are growing.

Researchers have attempted to use chemicals to delay bud break. Spraying eco dormant grapevines with solutions of alginate or various oils in early spring have been shown to delay bud break (Dami, et al., American Journal of Enology and Viticulture, Vol. 51(5):73-76 (2000)). However, growers have not adopted the use of these treatments to delay bud break because the delay is not very long and the oil treatment can cause the very severe side effect of bud mortality. One researcher, Gianfagna reported that a fall application of the ethylene releasing agent ethephon delayed bud break of peaches the following spring (Gianfagna, et al., Acta Hort. (ISHS) 239:203-206 (1989)). Few growers, however, have used ethephon treatments due to the potential negative side effect of increased gummosis. In summary, although some researchers have indicated that chemicals such as alginate, ethephon, or oils could delay bud break, these chemicals did not provide a practical solution to growers because of the negative side effects.

S-(+)-Abscisic acid (“ABA”) is a naturally-occurring hormone found in all higher plants (Cutler and Krochko. Formation and Breakdown of ABA. Trends in Plant Science, 4:472-478 (1999); Finkelstein and Rock, Abscisic acid Biosynthesis and Signaling, The Arabidopsis Book, ASPB, Monona, Md., 1-52 (2002)). S-(+)-Abscisic acid is reported to be found in all photosynthetic organisms (Cutler and Krochko, 1999; Finkelstein and Rock, 2002). ABA is involved in many major events of plant growth and development including dormancy, germination, bud break, flowering, fruit set, growth and development, stress tolerance, ripening, abscission, and senescence. ABA also plays an important role in plant tolerance to environmental stresses such as drought, cold, and excessive salinity.

Minimal research has been conducted with ABA and the role ABA has on dormancy is unclear. One study showed that exogenous ABA application to birch tree seedlings enhanced freezing tolerance and accelerated growth cessation in seedlings grown in short day conditions (SD, 12-hour photoperiod at 18′C), and slightly enhanced freezing tolerance in seedlings grown at low temperature (LT, 24-hour photoperiod at 4° C.) in both ecotypes tested (Li, et al., Tree Physiology 23; 481-487 (2003)). Li, et al., also reported that development of freezing tolerance and dormancy release induced by low temperatures was accompanied by changes in ABA levels. Alterations in ABA levels paralleled with development of freezing tolerance and preceded bud dormancy release in both ecotypes tested (Li, et al., Plant Science 167: 165-171 (2004)), Rimie showed that bud burst in Betula could be delayed by application of synthetic ABA (Rinne, et al., Tree Physiol. 14:549-561 (1994)). However, Hellman has reported that spring application of ABA on grapes had little effect on bud break (Hellman et al. Journal of the American Pomological Society 60(4): 178-186 (2006)).

The precise role of ABA in maintaining dormancy is not known. However, ABA has been postulated to be involved in the induction of endo-dormancy. By this hypothesis, endogenous ABA levels increase in the fall and act as a signal of shorter day length. This in turn hypothetically results in the inhibition of shoot growth, promotion of terminal bud set, and induction of endo-dormancy of buds (Arora, et al., HortScience Vol 38(5):911-921 (2003)). Furthermore, this scenario assumes that ABA levels decrease during the winter as chilling hours accumulate. When ABA levels or sensitivity to ABA decline below a threshold level, endo-dormancy ends and eco-dormancy continues to delay bud break. When temperatures increase in the spring, eco-dormancy ends and buds begin to grow and bud break occurs. However, this hypothesis has been questioned.

In order to determine the role ABA had on perennial plant bud break, Applicants conducted field studies for several years. After many experiments. Applicants determined that ABA had no appreciable effect on bud break, even when applied at high levels. Further, the timing of application of the ABA did not matter, because it failed to appreciably effect bud break at each and every application time.

In some situations, ABA analogs appear to be more potent than ABA, however analogs are thought to work in a similar way as ABA (i.e. some analogs effectively produce an ABA-like effect in reducing water use, see U.S. Pat. No. 6,004,905). Therefore, because ABA was unsuccessful at changing bud break timing, Applicants predicted that ABA analogs would also have no appreciable effect on bud break timing in perennial plants.

Further, ABA and ABA analogs are thought to be quickly metabolized by plants and, therefore, would not have long-term effects on the plants' growth. Therefore, Applicants thought that fall applications of ABA analogs would not affect the plants' reaction to changes in temperature several months later in the spring.

Therefore, there is a need in the art for an effective and practical way to delay bud break in perennial plants. Other researchers have failed to provide a solution and early cold temperature damage continues to plague growers and results in significant damage to crop-producing perennial plants. Applicants attempted to find a solution but unfortunately found that ABA was ineffective and speculated that ABA analogs would similarly fail to provide a much needed solution.

### SUMMARY OF THE INVENTION

Applicants unexpectedly found that ABA analogs will delay bud break in plants if the ABA analogs are applied before the plants enter dormancy. Specifically, Applicants found that ABA analogs provided delayed bud break and thus protection from cold temperature stress in perennial plants. Applicants found that even though they applied ABA analogs to the plants several months before the cold weather stress, the ABA analogs still provided excellent protection. Importantly, Applicants found that application of ABA analogs to perennial plants did not result in negative side effects.

In one aspect, the invention is directed to methods for applying ABA analogs to perennial plants prior to their cold temperature induced dormancy, for example, during the fall season. This application will successfully protect the plants for many months from the dangers of early emergence during the time when there is a risk of frost or near freezing temperatures, for example, during the early spring season.

The Examples provided below support Applicants assertion of unexpected results. In Examples 1-3, Applicants have shown that application of ABA and ABA analogs to plants in the spring does not affect the timing of bud break, In Example 4 (in part), Applicants have shown that application of ABA in the fall is also ineffective, as a soil drench. In contrast and unexpectedly, Applicants have shown in Examples 4 (in part) and 5-7 that ABA analogs, when applied in the fall, are very effective in prolonging the timing of bud break in perennial plants. In fact, ABA analogs produce delays in bud break when the analogs are applied at a fraction of the rate of ABA, and when ABA failed to show any delay. For example, in Example 6, Applicants unexpectedly found that ABA analog PBI-429 is about 100 times more potent than ABA when used on nectarine trees.

### DETAILED DESCRIPTION OF THE INVENTION

Embodiments of the present invention are directed to methods for delaying bud break in perennial plants comprising applying an ABA analog to the plants prior to cold temperature induced dormancy. This cold temperature induced dormancy can be due to the end of the summer growing season and the beginning of the fall dormancy season.

In an embodiment of the invention, the ABA analog is applied to the plant before the plants' leaves are abscised in reaction to exposure to colder temperatures.

In a further embodiment, the ABA analogs that are applied to the plants include at least one of PBI-425, PBI-524, PBI-429, PBI-696, and PBI-702.

In another embodiment, the ABA analog is applied to a grape plant. The ABA analog can be applied by spraying the grape vine, spraying the grape vine and grape leaves, or drenching the soil.

When the ABA analog is sprayed or used in a drench solution, it can be mixed with a solvent, such as water, to produce an appropriate concentration for spraying or drenching. In embodiments of the invention, the grape plant may be sprayed or drenched with a solution containing an ABA analog at a rate of from 10 to about 10,000 ppm. Preferably, the ABA analog is applied at a rate of from about 50 to about 2,000, and most preferably, the ABA analog is applied at a rate of from about 100 to about 1000 ppm.

The ABA analog may be applied to the grape plant at a rate of from about 3 to about 3,000 grams per acre (an acre is approximately 4046.86 square meters), preferably from about 15 to 600 grams per acre, more preferably at a rate of 30 to 400 grams per acre, and most preferred at a rate of from about 37.8 to about 378 grams per acre.

The ABA analog may be applied to the grape plant at a rate of from about 0.01 to about 2.0 grams per plant, preferably from about 0.04 to about 0.4 grams per plant, and most preferred at a rate of from about 0.125 grams per plant.

In a further embodiment, the ABA analog may be applied to only the part of the grape plant that will not be pruned the following spring, or the time following the cold temperature induced dormancy period. In this embodiment, resources are preserved because it allows for less ABA analog to be applied to the plant and may provide the same results as when the entire plant is sprayed. In this embodiment, the ABA analog may be applied to the specific parts of the grape plant at a rate of from about 0.01 to about 1.0 grams per vine, preferably at a rate of from about 0.004 to about 0.041 grams per vine. Alternatively, the ABA analog may be applied to the grape plant at a rate of about 0.05 to 40 grams per acre, or more preferably at a rate of from about 3 to about 40 grams per acre, and most preferably at a rate of from about 3 to about 4 grams per acre.

Spraying the part of the plant that will not be pruned involves directing the spraying apparatus to spray the buds and vines. This technique is known by those skilled in the art. For example, ProTone® Plant Growth Regulator (available from Valent® Biosciences) is effective for coloring grapes when the ProTone® is applied to just the clusters on the grape vines and the entire vine and leaf surface of the plant does not need to be sprayed. Similarly, spraying only an area of the plant that will develop the grapes the following spring (the buds near the cordon of the grape vine) may be an effective treatment resulting in desirable delays in bud break while being cost effective. In this case, growers could apply up to 90% less product to a limited amount of the plant and achieve the same results as spraying the entire plant. For example, instead of applying from about 30 to about 400 grams per acre, growers could apply just from about 3 to about 40 grams per acre of the ABA analog to the non-pruned parts of the plant.

In another embodiment, the ABA analog is applied to a stone fruit tree. The stone fruit tree can be an apricot, nectarine, peach, cherry, or plum tree. In a preferred embodiment, the ABA analog is applied to a nectarine tree. The ABA analog can be applied to the stone fruit tree, including the nectarine tree, at a rate of from about 10 to about 200 grams per acre.

The entire canopy of the tree may be sprayed, or alternatively, only the portion of the tree that will not be pruned the following spring may be sprayed, in this embodiment, a fraction of the amount of ABA analog may be applied to the portion of the tree that will not pruned the following spring. For example, from about 1 to 100 grains per acre, or from about 5 to about 50 grams per acre.

The method of only spraying the part of the canopy that is anticipated to not be pruned in the spring preserves resources because it allows for less ABA analog to be applied and may provide the same results as when the entire canopy is sprayed. This method provides a cost effective solution for growers concerned about early bud break.

It is understood that the concentration of the ABA analog can vary widely depending on the water volume applied to plants as well as other factors such as the plant age and size, and plant sensitivity to ABA analogs.

ABA analogs that selectively antagonize ABA activity that are useful in the present invention include PBI-51 (Abrams and Gusta, 1993, U.S. Pat. No. 5,201,931; Wilen, et al., 1993, Plant Physiol. 101: 469-476):

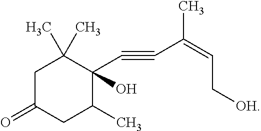 [SMILES: C/C(C#C[C@]1(O)C(C)CC(=O)CC1(C)C)=C/CO]

Presently preferred ABA analogs and derivatives useful in the present invention include PBI-425, PBI-429, PBI-524 PBI-696 and PBI-702.

For the purposes of this Application, ABA analogs are defined by Structures 1, 2 and 3, wherein for Structure 1:

the bond at the 2-position of the side chain is a cis- or trans-double bond,

the bond at the 4-position of the side chain is a trans-double bond or a triple bond,

the stereochemistry of the alcoholic hydroxyl group is S-, R- or an R,S-mixture,

the stereochemistry of the R₁ group is in a cis-relationship to the alcoholic hydroxyl group,

R₁ is ethynyl, ethenyl, cyclopropyl or trifluoromethyl, and
R₂ is hydrogen or lower alkyl

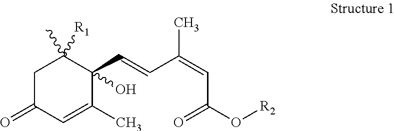

wherein lower alkyl is defined as an alkyl group containing 1 to 4 carbon atoms in a straight or branched chain, which may comprise zero or one ring or double bond when 3 or more carbon atoms are present.

For PBI-425, R1 is ethynyl, the orientation of the bonds for R1 and the hydroxyl group relative to the ring is alpha—in both cases, and the terminal carboxyl group is in the 1-orientation.

For PBI-429, R₁ is ethynyl and R₂ is a methyl group.

For PBI-524, R₁ is ethynyl and R₂ is hydrogen.

For PBI-696, R₁ is cyclopropyl and R₂ is a methyl group.

### For Structure 2:

the bond at the 2-position of the side chain is a cis- or trans-double bond,

the bond at the 4-position of the side chain is a triple bond,

the stereochemistry of the alcoholic hydroxyl group is S-, R- or an R,S-mixture,

R₁ is hydrogen or lower alkyl

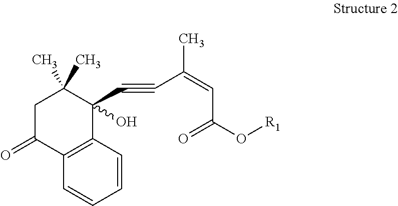

wherein lower alkyl is defined as an alkyl group containing 1 to 4 carbon atoms in a straight or branched chain, which may comprise zero or one ring or double bond when 3 or more carbon atoms are present.

For PBI-702, R₁ is a methyl group.

### For Structure 3:

the bond at the 2-position of the side chain is a cis or trans-double bond,

the bond at the 4-position of the side chain is a trans-double bond,

the stereochemistry of the alcoholic hydroxyl group is S-, R- or an R,S-mixture,

R₁ is hydrogen or lower alkyl

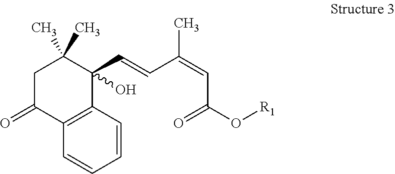

wherein lower alkyl is defined as an alkyl group containing 1 to 4 carbon atoms in a straight or branched chain, which may comprise zero or one ring or double bond when 3 or more carbon atoms are present.

It is understood by one skilled in the art that the methods of the present invention can also include applying the ABA analogs with other ingredients useful for assisting in the ABA analogs uptake into the plant, such as surfactants. For example, Silwet L-77 or Brij® 98 or other surfactants may be used in methods of the present invention.

As used herein, a delay in bud break means that the buds do not show green tissue when warm temperature conditions would usually initiate bud break. The desired delay is at least from about 5 days to about 10 days to sufficiently protect the buds from any freezing damage. It is preferable that the delay is at least 8 days.

As used herein, the season fall refers to the season in temperate climates that marks the transition from summer into winter, During this time, temperatures tend to decrease and the amount of daylight per day is reduced. Fall occurs around September/October in the Northern Hemisphere and around March/April in the Southern Hemisphere. As used herein, the season spring refers to the season in temperate climates that marks the transition from winter into summer. During this time, temperatures tend to increase and the amount of daylight per day is increased. Spring occurs around March/April in the Northern Hemisphere and around September/October in the Southern Hemisphere. It is understood that the beginning of the seasons is relative to the specific geographical location and climate of a region.

Throughout the application, colder or cooler temperatures are associated with the seasonal changes associated with the approaching winter season, and warmer temperatures are associated with the seasonal changes associated with the approaching summer season.

It is also contemplated that salts of ABA analogs may be utilized in accordance with the present invention.

As used herein, the term “salt” refers to the water-soluble salts of ABA analogs. Representative such salts include inorganic salts such as the ammonium, lithium, sodium, calcium, potassium and magnesium salts and organic amine salts such as the triethanolamine, dimethylethanolamine and ethanolamine salts.

As used herein, all numerical values relating to amounts, weight percentages and the like, are defined as “about” or “approximately” each particular values plus or minus 10% 10%). For example, the phrase “greater than 0.1%” is to be understood as encompassing values greater than 0.09%. Therefore, amounts within 10% of the claimed values are encompassed by the scope of the invention.

The percentages of the components in the formulations and comparative formulations are listed by weight percentage.

When dilute solutions of ABA analogs are prepared, the amounts are often listed in “ppm” referring to the parts per million of the ABA analogs that are present in the solution. The solution contains a solvent and may contain other excipients.

It is understood that the foregoing detailed description and accompanying examples are merely illustrative and are not to be taken as limitations upon the scope of the invention, which is defined solely by the appended claims and their equivalents. Various changes and modifications to the disclosed embodiments will be apparent to those skilled in the art. Such changes and modifications, including without limitation those relating to the active agents and excipients of the invention, may be made without departing from the spirit and scope hereof.

The following examples are offered by way of illustration only, not to limit the scope of this invention, as represented by the claims list attached herein.

### EXAMPLES

Examples 1, 2 and 3 demonstrate the ineffectiveness of soil drench or spray application of ABA or ABA analog to eco-dormant grapevines near the time of bud break. Examples 4-7 demonstrate the efficacy of soil drench or spray applications of ABA analog, but not ABA, in the fall for delaying bud break the following spring.

Chemical solutions were prepared with distilled water. Abscisic acid (S-ABA; ABA; S-(+)-abscisic acid; +-ABA, (+)-(S)-cis,trans-abscisic acid, (+)-(S)-cis,trans-ABA; S-ABA; (S)-5-(1-hydroxy-2,6,6)-trimethyl-4-oxo-2-cyclohexen-1-yl)-3-methyl-(2 Z,4E)-pentadienoic acid; CAS no. 21293-29-8, 10% active ingredient. ABA analog 8′acetylene-ABA methyl ester (PBI-429), was synthesized by Plant Biotechnology Institute, National Research Council of Canada (Saskatoon, Saskatchewan, Canada).

### Example 1

A study was conducted to evaluate the effect of spraying eco-dormant Concord grape vines with ABA or ABA analog plus surfactants on bud break. Mature field grown Concord grape vines were sprayed to runoff 2 times in the spring after pruning and before bud swell. Three replicates of 3 vines each were treated with each treatment solution. Treatments were arranged in a randomized complete block design down a single vineyard row, Bud break was monitored by counting the number of broken buds of the distal 5 buds on 4 proximal canes on the middle vine of each 3 vine replicate. Bud break was only very slightly delayed by any of the treatments compared to the water sprayed control (Table 1).

TABLE 1
Effect of ABA or ABA analog spray on bud break of field
grown Concord grapevines. N = 3 replicates of
3 vines each/treatment.

| | Average percent broken buds | | | | |
|---|---|---|---|---|---|
| | | | | | 100 ppm |
| Bud Break | | 1,000 ppm | 1,000 ppm | 10,000 ppm | PBI-429 |
| Evaluation | | ABA plus | plus 0.5% | ABA plus | plus 0.5% |
| Date | Water | 0.5% Brij 98 | Pentrabark | 0.5% Brij 98 | Brij 98 |
| April 24 | 10 | 8 | 2 | 5 | 8 |
| April 30 | 20 | 13 | 13 | 18 | 18 |

### Example 2

A study was conducted to determine the effect of ABA applied to the soil of potted grapevines near the time of bud break. Eco-dormant bare-root Seyval Blanc and Canadice grapevines were purchased from Concord Nurseries, North Collins, N.Y. Vines were planted in pots of Promix potting mixture and held in a 5° C. dark chamber prior to treatment. Plants were moved from the 5° C. chamber to a greenhouse set to 20° C. night/25° C. day with a 12 hour light and 12 hour dark light cycle to promote bud break. One group of 5 plants was treated with 250 ml of 1000 ppm ABA (250 mg) as a soil drench 2 days after moving the vines to warm conditions. Another group of vines was treated 6 days after warming and another group of 5 plants was treated 10 days after warming. With the Seyval Blanc grapevines one group of 5 plants was treated at all 3 timings 2, 6, and 10 days after warming (750 mg total). Another group of 5 vines was not treated and acted as an untreated control. The number of broken buds (showing green tissue) per vine was determined 13, 14, 15, and 16 days after treatment fbr Seyval Blanc (Table 2) and 13, 14, 15, 16, 17 and 18 days after treatment for Canadice grapevines (Table 3).

Application of 1000 ppm ABA soil drench 13-16 days before bud break delayed bud break, but only for 3.5 days. The desired delay is 5-10 days to protect against late freezes. Soil drench treatment in the spring is not a desirable application situation due to high volume of water the grower would have to apply. A foliar spray would be preferable but the lack of leaves makes spray application in the spring an inefficient way to deliver active ingredients to the plant.

TABLE 2
Effect of ABA soil drench on bud break of potted
Seyval Blanc grapevines. N = 5 vines/treatment.

| | Average number of broken buds per vine | | | | |
|---|---|---|---|---|---|
| | | | | | 1000 ppm |
| Bud Break | | 1000 ppm | 1000 ppm | 1000 ppm | ABA 2, 6 |
| Evaluation | | ABA 2 Days | ABA 6 Days | ABA 10 | and 10 Days |
| (Days After | | After | After | Days After | After |
| Warming) | Untreated | Warming | Warming | Warming | Warming |
| 13 | 2.6 | 0.4 | 0.2 | 1.8 | 1.2 |
| 14 | 5.0 | 2.2 | 1.6 | 6.0 | 4.4 |
| 15 | 7.6 | 3.6 | 2.6 | 8.6 | 4.8 |
| 16 | 9.8 | 6.8 | 6.8 | 11.4 | 7.0 |

TABLE 3
Effect of ABA soil drench on bud break of potted
Canadice grapevines. N = 6 vines/treatment.

| | Average number of broken buds per vine | | | |
|---|---|---|---|---|
| Bud Break | | 1000 ppm | 1000 ppm | 1000 ppm |
| Evaluation | | ABA | ABA | ABA |
| (Days After | | 2 Days After | 6 Days After | 10 Days After |
| Warming) | Untreated | Warming | Warming | Warming |
| 13 | 0.7 | 0 | 0.2 | 0.5 |
| 14 | 2.5 | 0 | 0.7 | 1.8 |
| 15 | 3.2 | 0.8 | 1.2 | 2.3 |
| 16 | 3.3 | 1.2 | 1.7 | 2.3 |
| 17 | 3.3 | 1.7 | 2.3 | 2.3 |
| 18 | 3.5 | 1.7 | 2.5 | 2.7 |

### Example 3

A study was conducted to determine the effect of spraying Concord grapevines with ABA or ABA analog PBI-429 during bud break. Potted concord grapevines were placed in greenhouse conditions to promote bud break and the vines were repeatedly sprayed with ABA or ABA analog solutions. The vines were sprayed 2, 4, 8, 12 and 14 days after exposure of the vines into bud break promoting temperatures. Bud break was rated 6, 7, 8, 11, 12, 13, 14, 15, 19 and 20 days after vines were placed in warm bud break promoting conditions. The average number of broken buds (buds showing green) was not significantly impacted over time by repeated spray application of ABA or ABA analog during the bud break period (Table 4).

TABLE 4
Effect of foliar application of ABA or ABA analog to potted Concord
grapevines during the bud break period on the number of broken
buds per vine. N = 6 vines per treatment

| Bud Break | Average number of broken buds per vine | | | |
|---|---|---|---|---|
| Evaluation | | 0.05% | 1000 ppm ABA | 100 ppm PBI-429 |
| (Days After | | Silwet | in 0.05% Silwet | in 0.05% Silwet |
| Warming) | Water | L77 | L77 | L77 |
| 6 | 0 | 0.2 | 0.2 | 0.7 |
| 7 | 0 | 0.3 | 0.2 | 0.7 |
| 8 | 0.5 | 0.7 | 0.8 | 1.7 |
| 11 | 2.3 | 3.3 | 2.8 | 2.5 |
| 12 | 3.0 | 3.5 | 3.2 | 2.5 |
| 13 | 3.8 | 4.7 | 3.8 | 3.0 |
| 14 | 3.8 | 4.8 | 4.8 | 3.0 |
| 15 | 4.2 | 6.2 | 5.3 | 4.0 |
| 19 | 4.8 | 6.8 | 7.0 | 4.3 |
| 20 | 4.8 | 6.8 | 7.0 | 4.3 |

### Example 4

A study was conducted to determine the effect of application of ABA or ABA analog as a soil drench in the fall on bud break of potted Concord grapevines the following spring. Two year old eco-dormant Concord grapevines were obtained from a Concord Nurseries in the spring. Bare-root vines were planted in 14 liter pots filled with Promix BX (available from Premier Horticulture Inc. Quakertown, Pa.) and grown outside for about 5 months (May October) prior to treatment. Plants received irrigation as needed and fertilized weekly (1 g/L all purpose fertilizer 20-20-20, The Scotts Company, Marysville, Ohio). Uniform plants were selected for the study. A total of 1000 mL of water or chemical solution was applied to the soil of each plant.

After chemical treatment, the ten replicate plants per treatment were arranged in a randomized complete block experimental design. The potted vines were surrounded by bark chips the depth of the soil in the pot to insulate the roots and prevent cold damage. The plants became dormant for the winter. In the following spring the vines were pruned to 5 buds per vine before bud break and bud break was monitored over time (Table 4). The buds were rated for bud break periodically on a scale from 1 for no growth to 6 for three or more leaves showing

Potted Concord grapevines were treated with 1000 mL water, solution containing 1000 mg ABA or solution containing 100 mg PBI-429. The dose of RBI-429 was used at one-tenth of ABA dose based on the preliminary results.

Bud break progression of vines treated with 1000 mg ABA was similar to that of untreated vines (Table 5). Surprisingly bud break of vines treated with 100 mg ABA analog PBI-429 in the all was delayed by about 2 weeks compared to that of ABA treated or untreated vines.

TABLE 5
Effect of fall applied ABA and ABA analog PBI-429 on bud
break of Concord grapevines in the following spring.

| | Average rating of bud break (1-6 scale). | | |
|---|---|---|---|
| | | | 100 ppm PBI-429 |
| | | 1000 ppm ABA | (100 mg PBI- |
| Date | Water | (1000 mg ABA/pot) | 429/pot) |
| Apr. 23, 2008 | 1.1 | 1.0 | 1.0 |
| April 28 | 1.6 | 1.6 | 1.0 |
| April 30 | 1.7 | 1.8 | 1.0 |
| May 2 | 1.8 | 1.8 | 1.0 |
| May 5 | 2.1 | 2.1 | 1.0 |
| May 7 | 2.5 | 2.6 | 1.0 |
| May 9 | 2.8 | 2.9 | 1.0 |
| May 12 | 3.0 | 3.0 | 1.0 |
| May 14 | 3.3 | 3.0 | 1.0 |
| May 16 | 3.6 | 3.4 | 1.0 |
| May 19 | 4.4 | 4.2 | 1.2 |
| May 21 | 4.5 | 4.6 | 1.2 |
| May 23 | 5.0 | 4.9 | 1.8 |
| May 28 | 5.5 | 5.4 | 2.7 |

### Example 5

A study was conducted to determine the effect of spraying grapevines with ABA analogs in the fail on bud break the following spring. Mature Cabernet Franc grapevines growing in a research vineyard in Benton Harbor, Mich. were sprayed to drip with surfactant alone or surfactant and ABA analog on Oct. 25, 2008. Vines were sprayed with approximately 300 ml (113 grams ABA analog/acre) applied to each of 9 vines per treatment arranged in three replicates of three vines each. The following spring prior to bud break the vines were pruned to 3-6 buds per spur and bud break of 40 buds per vine (4 buds on each of 10 spurs) was rated periodically using the BBCH (Biologische Bundesanstalt, Bundessortenamt und Chemische Industrie) scale of development where a rating of 1 represents the first sign of bud swelling and 99 represents a defoliated plant re-entering dormancy at the end of the growing season.

Unexpectedly foliar application ABA analogs PBI-429 and PBI-524 at about 0.125 grams per vine delayed bud break the following spring by about 15 days (Table 6). Significant bud break delay was unexpected due to the low dose per vine on large mature vines and the months between application and observed effect. Both analogs were very effective at delaying bud break without apparent impact on bud mortality.

TABLE 6
Effect of fall foliar application of ABA analogs on bud break
of Cabernet Franc grapevines the following spring.
N = three 3 vine replicates

| | Average BBCH rating of bud developmental stages. | | |
|---|---|---|---|
| | | 300 ppm PBI-429 in | 300 ppm PBI-524 in |
| Date | 0.1% Brij 98 | 0.1% Brij 98 | 0.1% Brij 98 |
| May 1, 2009 | 1.8 | 0.1 | 0.0 |
| May 5 | 2.8 | 0.4 | 0.4 |
| May 12 | 5.0 | 1.0 | 1.0 |
| May 21 | 8.1 | 3.2 | 3.7 |
| May 28 | 14.2 | 6.0 | 6.7 |

Foliar application ABA analogs PBI-429 and PBI-524 at about 0.125 grams per vine in the fall delayed maturation of the following crop of grapes as measured by juice pH and Brix (Table 7).

TABLE 7
Effect of fall foliar application of ABA analogs on fruit maturity
of Cabernet Franc grapevines the following fall. N = three
3 cluster replicates

| | Average pH and Brix of grapes harvested on Oct. 24, 2009. | | |
|---|---|---|---|
| | | 300 ppm PBI-429 in | 300 ppm PBI-524 in |
| | 0.1% Brij 98 | 0.1% Brij 98 | 0.1% Brij 98 |
| pH of juice | 3.34 | 3.16 | 3.14 |
| Brix of juice | 20.84 | 19.32 | 19.37 |

When the control fruit had reached maturity three clusters of grapes were randomly harvested from each 3 vine replicate. Brix and pH measurements were made of the juice expressed by hand squeezing the grape clusters. Both the pH and Brix readings were lower for the grapes from the ABA analog treated vines indicating a delay of fruit maturity.

### Example 6

A study was conducted to determine the effect of spraying nectarine trees with ABA or ABA analogs in the fall on bud break the following spring. Mature PF-11 nectarine trees were sprayed to drip with surfactant alone or surfactant and ABA or ABA analog on Oct. 19, 2009. Trees were sprayed with approximately 500 ml (20.5 grams ABA analog/acre) applied to each of 6 trees per treatment arranged in a randomized complete block design. The following spring bud break on pre-selected branches was monitored.

Surprisingly the delay of bud break from the ABA analog PBI-429 applied at 100 ppm was very similar to the delay from application of 10,000 ppm ABA (Table 8). The finding that the analog was about 100 times more potent than ABA was an unexpected result. In other bioassays and published accounts the most efficacious ABA analogs appear to be about 10 to 20 times more potent than ABA.

TABLE 8
Effect of fall foliar application of ABA analogs on bud break
of PF-11 nectarines the following spring. N = 2 branches
on each of six single tree replicates

| | Percentage of broken floral buds. | | |
|---|---|---|---|
| | | 10,000 ppm ABA in | 100 ppm PBI-429 in |
| Date | 0.1% Brij 98 | 0.1% Brij 98 | 0.1% Brij 98 |
| April 8 | 100 | 78 | 56 |

Foliar application of the ABA analog PBI-429 and to nectarine trees in the fall reduced the number of fruit per tree the following spring (Table 9).

TABLE 9
Effect of fall foliar application of ABA or ABA analog on fruit number
per tree the following spring. N = six single tree replicates

| | Average number of fruit per tree. | | |
|---|---|---|---|
| | | 10,000 ppm ABA in | 100 ppm PBI-429 in |
| Date | 0.1% Brij 98 | 0.1% Brij 98 | 0.1% Brij 98 |
| June 10 | 114 | 55 | 75 |

Treatment of nectarine trees in the fall with the ABA analog delayed bud break and reduced fruitfulness the following spring similar to ABA applied at 100 times higher dose.

### Example 7

A study was conducted to determine the elect of spraying Cabernet Franc grapevines with ABA analog PBI-425 or PBI-524 in the fall on bud break the following spring. Mature Cabernet Franc grapevines growing in a research vineyard in Benton Harbor, Mich. were sprayed to drip with surfactant alone or surfactant and ABA analog on Oct. 21, 2011. Vines were sprayed with approximately 300 ml applied to each of 9 vines per treatment arranged in three replicates of three vines each. Applied at about 100 gallons per acre 100 ppm treatment represents 37.8 grams per acre and 1000 ppm represents 378.4 grams per acre. In the spring after treatment prior to bud break the vines were pruned to 3-6 buds per spur and bud break of the entire vine was determined in the spring.

Surprisingly foliar application ABA analogs PBI-425 and PBI-524 at about 0.03-0.3 grams per vine delayed bud break the following spring (Table 10). Significant bud break delay was unexpected due to the low dose per vine on large mature vines and the months between application and observed effect. Both analogs were very effective at delaying bud break without apparent impact on bud mortality.

TABLE 10
Effect of foliar application of ABA analogs in the fall on bud
break of Cabernet Franc grapevines the following spring.
Average number of broken buds per vine on Apr. 11, 2012

| | 100 ppm PBI- | 1000 ppm PBI- | 100 ppm PBI- |
|---|---|---|---|
| 0.1% Silwet | 524 in 0.1% | 524 in 0.1% | 425 in 0.1% |
| Brij 98 | Silwet Brij 98 | Silwet Brij 98 | Silwet Brij 98 |
| 17 | 13 | 2 | 11 |

1. A method for delaying bud break in perennial plants comprising applying an abscisic acid (ABA) analog to the plants prior to cold temperature induced dormancy.

2. The method of claim 1 wherein the ABA analog is applied to the plant prior to cold temperature induced leaf abscission.

3. The method of claim 1 wherein the ABA analog is selected from the group consisting of PBI-425, PBI-524, PBI-429, PBI-696, and PBI-702.

4. The method of claim 1 wherein the ABA analog is applied to the plant at a rate of from about 100 to about 1000 ppm.

5. The method of claim 1 wherein the perennial plant is a grape plant.

6. The method of claim 5 wherein the ABA analog is applied to the grape plant by drenching the soil or spraying the grape plant.

7. The method of claim 6 wherein the ABA analog is applied to the grape plant at a rate of from about 30 to about 400 grams per acre.

8. The method of claim 6 wherein the ABA analog is applied to the grape plant at a rate of from about 0.04 to about 0.4 grains per vine.

9. The method of claim 6 wherein the ABA analog is applied to the grape plant by spraying the buds on the vine that will not be pruned following the cold temperature induced dormancy.

10. The method of claim 9 wherein the ABA analog is applied to the grape plant at a rate of from about 3 to about 40 grams per acre.

11. The method of claim 9 wherein the ABA analog is applied to the grape plant at a rate of from about 0.004 to about 0.041 grams per vine.

12. The method of claim 1 wherein the perennial plant is a stone fruit tree.

13. The method of claim 12 wherein the stone fruit tree is a nectarine tree.

14. The method of claim 13 wherein the ABA analog is applied to the nectarine tree at a rate of from about 10 to about 200 grams per acre.

15. The method of claim 12 wherein the ABA analog is applied to the stone fruit tree by spraying the buds on the vine that will not be pruned following the cold temperature induced dormancy
